(19) United States
(12) Patent Application Publication
(10) Pub. No.: US 2006/0109193 A1
(43) Pub. Date: May 25, 2006

(54) Base station panel antenna with dual-polarized radiating elements and shaped reflector

(75) Inventor: Charles Williams, Ferntree Gully (AU)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/267,293

(22) Filed: Nov. 7, 2005

(30) Foreign Application Priority Data
Nov. 23, 2004 (EP) 04292758.2

(51) Int. Cl. H01Q 21/26

(52) U.S. Cl. 343/797

(57) ABSTRACT

A base station panel antenna for use in cellular communication systems comprises at least an array of dual polarized radiating elements mounted on a reflector plate for reflecting polarized radio frequency signals wherein the reflector structure presents a horn-like shape for each radiating element.

### BACKGROUND OF THE INVENTION

The invention is based on a priority application EP 04292758.2 which is hereby incorporated by reference.

The present invention relates generally to dual polarization antenna arrays and more specifically to base station panel antennas comprising a plurality of dual-polarized radiating elements capable of receiving and/or transmitting electromagnetic waves having two different orthogonal polarizations.

Base station panel antennas used to provide radio coverage for cellular communication systems commonly operate with dual polarizations. Such base station panel antennas, for example the one disclosed in U.S. Pat. No. 6,025,798, typically comprise an array of dual polarized radiating elements mounted on a substantially flat and rectangular reflector.

In the development of the radiating portion of dual polarized panel antennas for cellular mobile base stations it is difficult to obtain a combination of physical dimensions that simultaneously satisfies several antenna performance characteristics such as the antenna beamwidth, the front-to-back ratio, and the cross-polar discrimination, particularly over a wide range of azimuth angles.

### SUMMARY OF THE INVENTION

It is the object of the invention to provide a new base station panel antenna with improved antenna performance characteristics.

The object is achieved by a base station panel antenna for use in cellular communication systems comprising at least an array of dual polarized radiating elements mounted on a reflector structure for reflecting polarized radio frequency signals wherein the reflector structure has a horn-like shape for each radiating element.

According to a preferred embodiment of the invention, the shaped reflector structure of the base station panel antenna has a “conical” horn shape or a “pyramidal” horn shape associated with each radiating element. The sides of each horn-like shaped module could be planar, curved or stepped.

The principle of shaping an antenna reflector is well established, for example shaped parabolic antennas for satellite communications. However the objective in those known cases is quite different and usually relates to optimizing the radiating performance in the direction of maximum radiation, which is the on-axis direction. Also, since those known antennas are basically unidirectional there is no need to optimize their wide-angle performance.

The base station panel antenna according to the current invention presents technical and manufacturing advantages over other known dual-polarized array approaches. From extensive electromagnetic modeling it has been found that if the usual planar or box-shaped “backplane” or “groundplane” is replaced by the tapered horn-like reflector structure of the invention, the wide angle radiating characteristics can be significantly improved, increasing the discrimination between the two polarization fields at wide azimuth angles from the peak of the main beam, while simultaneously improving several other conditions such as the azimuth beamwidth and the front-to-back ratio.

Other advantageous configurations of the invention emerge from the dependent claims, the following description and the drawings. For example it is seen advantageous that the reflector structure of the panel antenna according to the invention can be manufactured with low cost e.g. by metal stamping, metal die-casting or metal-plated plastic injection molding, and in modular way, which facilitates antenna design scalability.

### BRIEF DESCRIPTION OF THE DRAWINGS

An embodiment example of the invention is now explained with the aid of FIGS. 1 and 2.

FIG. 1 shows a base station panel antenna for use in cellular communication systems according to the invention.

FIG. 2 shows a shaped reflector structure for a base station panel antenna according to the invention.

### DETAILED DESCRIPTION OF THE DRAWINGS

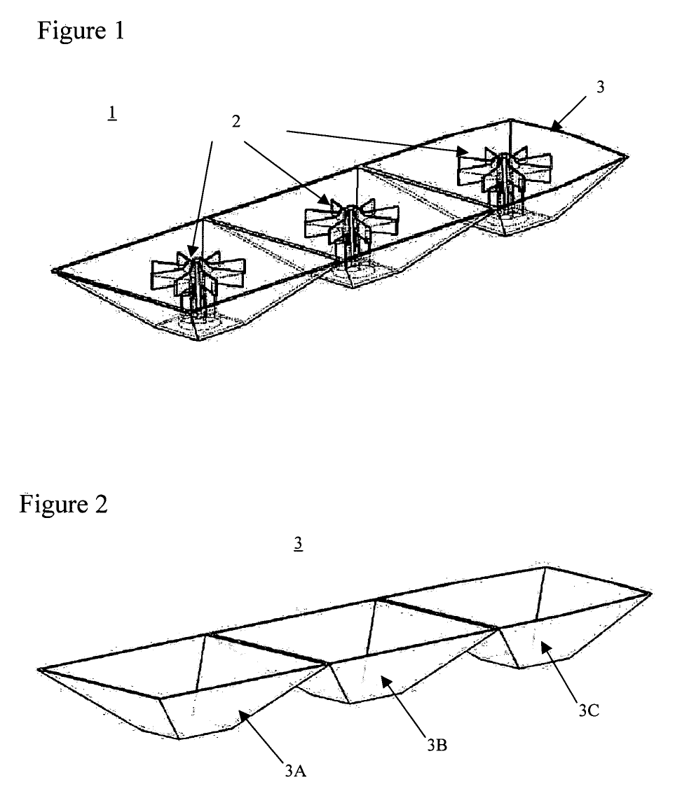

FIG. 1 shows a base station panel antenna 1 for use in cellular communication systems according to the invention with a 1×3 array of dual-polarized radiating elements 2 mounted on a reflector structure 3, having a pyramidal shape for each radiating element 2, for reflecting polarized radio frequency signals

FIG. 2 is a shows a shaped reflector structure 3 for a base station panel antenna according to the invention.

In the example of FIG. 2 the reflector 3 has three modules 3A, 3B, 3C of pyramidal shape, one for each dual-polarized radiating element of the base station panel antenna. The sides of each pyramidal shaped module 3A, 3B, 3C are planar but alternatively, they could also be curved or stepped in shape.

The shaped reflector structure 3 can be manufactured in a modular way by manufacturing each horn-like shaped module 3A, 3B, 3C separately and then assembling them together or by manufacturing the whole shaped reflector structure 3 in one step.

Of course it is understood that the base station panel antenna of the invention is not limited to a particular number of reflector modules, an array of particular dual polarized radiating elements or to a particular horn-like reflector shape.

1. A base station panel antenna for use in cellular communication systems comprising at least an array of dual polarized radiating elements mounted on a reflector structure for reflecting polarized radio frequency signals wherein the reflector structure has a horn-like shape for each radiating element.

2. The base station panel antenna of claim 1 characterized in that the horn-like shape is a conical horn shape or a pyramidal horn shape.

3. The base station panel antenna of claim 1 characterized in that the sides of the horn-like shape are planar, curved or stepped.

4. The panel antenna of claim 1 characterized in that the reflector structure is manufactured by metal stamping, metal die-casting or metal-plated plastic injection molding.

5. The panel antenna of claim 1 characterized in that the reflector structure is manufactured by assembling a number of reflector modules.
